(19) United States
(12) Patent Application Publication
(10) Pub. No.: US 2025/0261003 A1
(43) Pub. Date: Aug. 14, 2025

(54) Method for Providing an Adjustable Distributed System

(71) Applicant: Robert Bosch GmbH, Stuttgart (DE)

(72) Inventors: Laura Beermann, Waldbronn (DE); Kevin Schmidt, Herrenberg (DE); Tobias Frye, Braunschweig (DE)

(21) Appl. No.: 18/967,258

(22) Filed: Dec. 3, 2024

(30) Foreign Application Priority Data
Dec. 8, 2023 (DE) 10 2023 212 384.3

(51) Int. Cl. H04W 24/02; H04L 41/16; H04W 28/02

(52) U.S. Cl. CPC H04W 24/02; H04L 41/16; H04W 28/0236

(57) ABSTRACT

A method is for providing an adjustable distributed system. The method includes determining at least one characteristic of a wireless communication between at least two components of the distributed system, and adjusting at least one parameter of a control function of one of the at least two components and/or at least one communication parameter of the wireless communication based on the determined at least one characteristic. The method further includes providing the distributed system based on the adjusted at least one parameter of the control function and/or the adjusted communication parameter.

The invention relates to a method for providing an adjustable distributed system The invention further relates to a computer program, a device, and a storage medium for this purpose.

### PRIOR ART

Control functions are usually designed for a fixed destination with a specific frequency, which depends on the hardware and the intended functionality. Information between sensor, actuator or various control functions is exchanged via wired networks (e.g. in cars via CAN). If the control function is designed for wireless communication, it is usually designed for worst-case communication. However, the quality of wireless communication for migratable control functions can change depending on the hardware used or on external conditions and can be better or worse accordingly.

For example, a method is known from U.S. Pat. No. 11,223,969B2 in which information about a communication link between wireless devices is determined using a prediction server from which this information can be downloaded. However, no measures are derived from this information.

### DISCLOSURE OF THE INVENTION

The subject matter of the invention is a method having the features of claim 1, a computer program having the features of claim 9, a device having the features of claim 10, and a computer-readable storage medium having the features of claim 11. Further features and details of the invention will emerge from the respective dependent claims, the description, and the drawings. Features and details which are described in connection with the method according to the invention naturally also apply in connection with the computer program according to the invention, the device according to the invention, and the computer-readable storage medium according to the invention, and vice versa in each case, so that reference is always or can always be made to the individual aspects of the invention with respect to the disclosure.

The subject matter of the invention is, in particular, a method for providing an adjustable distributed system, comprising the following steps, wherein the steps can be carried out repeatedly and/or in succession. The distributed system may, for example, comprise at least one vehicle or several vehicles and/or an infrastructure system and/or an external data processing device such as a cloud server.

In a first step, preferably at least one characteristic of a wireless communication between at least two components of the distributed system is determined. This can be determined, for example, by measurement using at least one sensor or virtually using appropriate software. The at least two components can each be, for example, a vehicle and/or an infrastructure system and/or an external data processing device such as a cloud server. Wireless communication can be, for example, a direct communication technology such as ITS-G5 (802.11p) or PC5 (LTE-V2X/C-V2X/5G-V2X) or a cellular communication technology such as 4G, 5G or 6G.

In a further step, at least one parameter of a control function of one of the at least two components and/or at least one communication parameter of the wireless communication is preferably adapted on the basis of the determined at least one characteristic. The control function may be implemented on a controller of the one of the at least two components. As a result, the determined at least one characteristic can advantageously be taken into account when selecting or adjusting the at least one parameter of the control function and/or the at least one communication parameter of the wireless communication.

In a further step, the distributed system is preferably provided on the basis of the adapted control function and/or the adapted communication parameter. This allows the control function in the distributed system to be used flexibly on different types of components and in different environmental conditions.

Preferably, the invention can provide that the adjusting of the at least one communication parameter is carried out only after the adjusting of the at least one parameter of the control function has been carried out or when the adjusting of the at least one parameter of the control function is disabled. This allows prioritization to be carried out, according to which the stability of the control function is first ensured before at least one communication parameter is adjusted for further optimization. If adjusting of the least one parameter of the control function is not possible, for example because a change would pose a safety risk or because no intervention in the control function is intended, it may be advantageous to provide flexibility and adaptability in the distributed system by adjusting of the at least one communication parameter. The adjusting of the at least one parameter of the control function can take into account a current state of the implementation, for example, whether it is critical or non-critical, which can be determined based on a history (e.g., stable mode at target value or transient situation). Accordingly, adjusting can be blocked or disabled in an inappropriate situation.

Furthermore, it is optionally possible within the scope of the invention for the method to also comprise the following step:
Initiating a request to determine the at least one characteristic of the wireless communication by another component of the distributed system.
   The other component can be another vehicle or an infrastructure system, for example. The further component can also be one of the at least two components of the distributed system between which the wireless communication is carried out. In this way, the at least one characteristic can be advantageously determined independently of one of the at least two components, which is preferably designed as a vehicle. Subsequently, the at least one parameter of the control function of one of the at least two components and/or the at least one communication parameter of the wireless communication can be adapted on the basis of the at least one characteristic determined by the further component.

The at least one characteristic of the wireless communication is selected in particular from:
A latency in the transmission of data, wherein a degree of jitter can also be described, jitter being in particular a fluctuating transmission frequency or a resulting fluctuating transmission latency,
A data transmission rate of the wireless communication, for example an available bit rate,
A periodicity in the transmission of data, i.e. in particular how often data is sent and/or received,
The availability of a data connection for wireless communication, i.e. in particular when and whether the data connection is available and whether it is possible to send and receive data. This can also be determined as packet-to-receiver ratio or consecutive packet loss,
Data integrity, or trustworthiness, of wireless communication data, which may depend on functional security development standards, for example.

According to a further advantage, it may be provided that the adjusting of the at least one parameter of the control function is carried out by a machine learning model, wherein the machine learning model is based on a training in which the machine learning model carries out an optimization of the at least one parameter of the control function on the basis of the at least one characteristic in order to fulfill at least one predetermined requirement on the control function by means of the optimization. The machine learning model can be a neural network, for example. The at least one predefined requirement is, for example, a range or an uncertainty for the control function, which should be maintained by the control function. In a traffic context, the predefined requirement can, for example, specify an area or an uncertainty for a safe distance to a lateral lane marking or to a vehicle in front.

Alternatively, uncertainty quantification methods can be used to characterize the behavior of the system in addition to the nominal parameters (periodicity, latency, etc.). An optimal reparameterization of the control function for new conditions can also be calculated using a stochastic linear-quadratic optimal control design, for example. Classic functions or methods that change one or more parameters of the control function depending on the at least one characteristic are also conceivable.

Furthermore, it is possible that the adjusting the at least one communication parameter comprises at least one of the following steps:
Prioritize communication channels of wireless communication,
Changing a used communication channel of the wireless communication, wherein, for example, a bandwidth or frequency can be changed or alternative technology can be used,
Changing a periodicity in the transmission of data,
Changing a modulated coding scheme (MCS) when transmitting data, wherein the selected modulated coding scheme can be used to weigh up the robustness of the transmission against the resulting data transmission rate.
   The at least one communication parameter can thus be a prioritization of the communication channels, a used communication channel, a periodicity in the transmission of data, or a modulated coding scheme when transmitting data.

Furthermore, the invention may provide that the adjusting of the at least one parameter of the control function comprises at least one of the following steps:
Configuring a control gain of the control function, wherein the control gain determines in particular an aggressiveness and a power of the control function,
Adjusting of at least one target value and/or reference value of the control function, wherein the at least one setpoint and/or reference value is, for example, a distance to be maintained from a vehicle in front,
Adjusting a resource demand of the control function, wherein the resource demand is, for example, a length of a time horizon in the case of a model-predictive control, it also being conceivable in this context that activation of at least one further sub-function, such as a delay compensation, is carried out,
Adjusting a periodicity of an activation of the control function, wherein the periodicity is, for example, a sampling frequency of the control function,
Adjusting a communication behavior of the control function, wherein the communication behavior describes, for example, a periodicity and/or a triggering of the wireless communication.
   The at least one parameter can therefore be a control gain, a target value or reference value, a resource demand, a periodicity or a communication behavior of the control function.

According to a favorable further development of the invention, it can be provided that one of the at least two components is a vehicle and the control function controls a vehicle function, preferably a determination and/or provision of a driving trajectory for the vehicle. In particular, the method according to the present invention can be advantageous for a vehicle, since the vehicle should be able to be used in different environmental conditions and to communicate with different components such as other vehicles, infrastructure systems and/or external data processing devices such as cloud servers and to perform the control function reliably on the basis of the communication. The control can be particularly relevant with regard to the determination and/or provision of a driving trajectory, as reliable control, for example for the safety of occupants of the vehicle or other vehicles or passers-by, can be decisive here.

It is possible that the method according to the invention is used in a vehicle. The vehicle may, for example, be designed as a motor vehicle and/or a passenger vehicle and/or an autonomous vehicle. The vehicle may comprise a vehicle device, e.g., for providing an autonomous driving function and/or a driver assistance system. The vehicle device may be configured to control and/or accelerate and/or brake and/or steer the vehicle, at least partially automatically.

Another object of the invention is a computer program, in particular a computer program product, comprising commands which, when the computer program is executed by a computer, cause the computer to carry out the method according to the invention. The computer program according to the invention thus brings with it the same advantages as have been described in detail with reference to a method according to the invention.

The invention also relates to a device for data processing which is configured to carry out the method according to the invention. The device can be a computer, for example, that executes the computer program according to the invention. The computer can comprise at least one processor for executing the computer program. A non-volatile data memory can be provided as well, in which the computer program can be stored and from which the computer program can be read by the processor for execution.

The invention can also relate to a computer-readable storage medium, which comprises the computer program according to the invention and/or commands that, when executed by a computer, prompt said computer program to carry out the method according to the invention. The storage medium is configured as a data memory such as a hard drive and/or a non-volatile memory and/or a memory card, for example. The storage medium can, for example, be integrated into the computer.

In addition, the method according to the invention can also be designed as a computer-implemented method.

Further advantages, features, and details of the invention emerge from the following description, in which exemplary embodiments of the invention are described in detail with reference to the drawings. The features mentioned in the claims and in the description can each be essential to the invention individually or in any combination. The figures show:

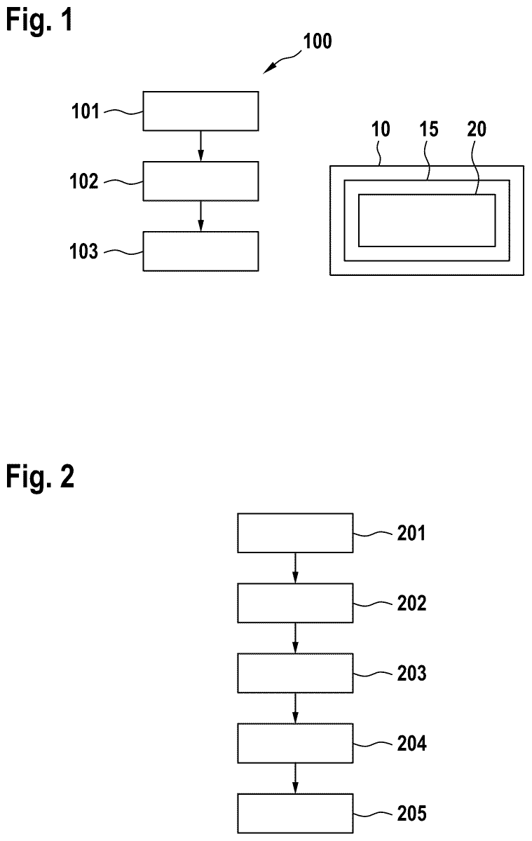

FIG. 1 a schematic visualization of a method, a device, a storage medium and a computer program according to exemplary embodiments of the invention.

FIG. 2 a schematic illustration of a method according to exemplary embodiments of the invention,

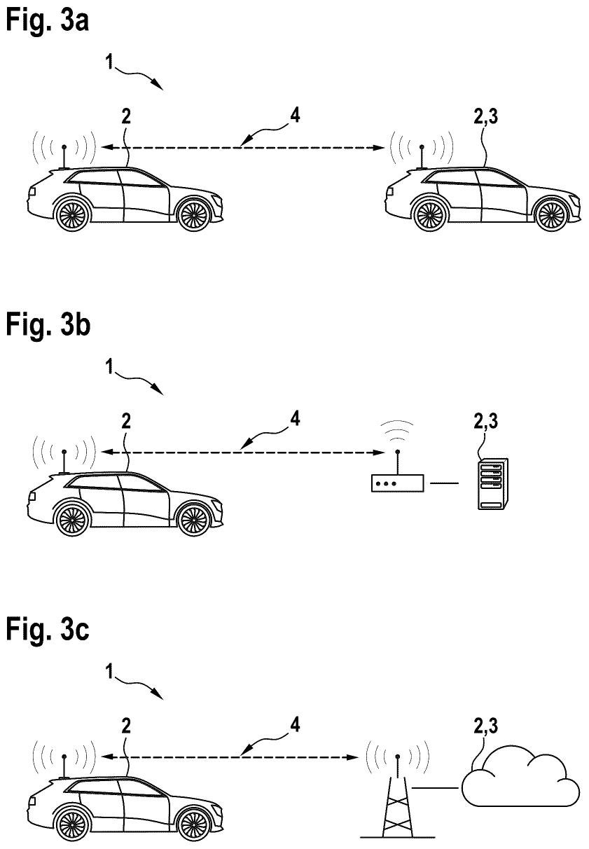

FIG. 3a a schematic illustration of a possible distributed system according to exemplary embodiments of the invention,

FIG. 3b a schematic illustration of a further distributed system according to exemplary embodiments of the invention,

FIG. 3c a schematic illustration of a further distributed system according to exemplary embodiments of the invention,

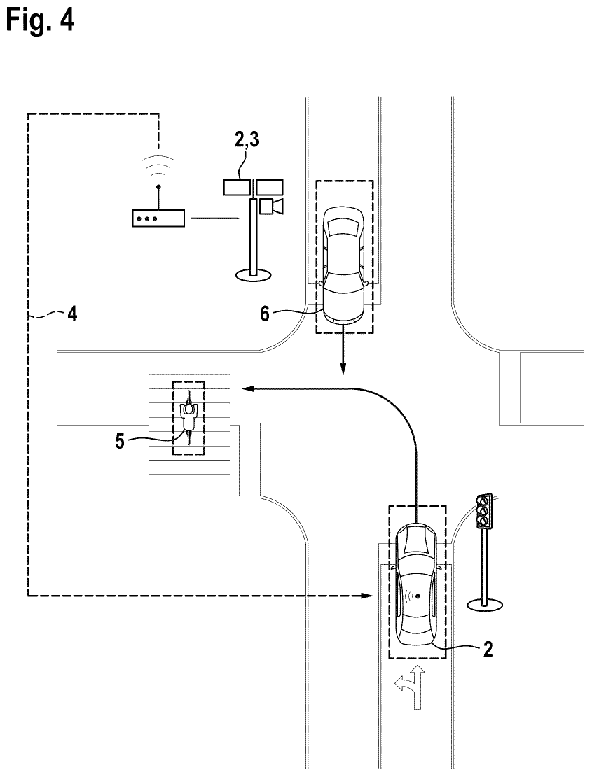

FIG. 4 a schematic illustration of a further possible distributed system in a traffic situation according to the exemplary embodiments of the invention.

FIG. 1 schematically illustrates a method 100, a device 10, a storage medium 15, and a computer program 20 according to exemplary embodiments of the invention.

In particular, FIG. 1 shows an exemplary embodiments of a method 100 for providing an adjustable distributed system 1. In a first step 101, at least one characteristic of a wireless communication 4 between at least two components 2 of the distributed system 1 is determined. In a second step 102, at least one parameter of a control function of one of the at least two components 2 and/or at least one communication parameter of the wireless communication 4 is preferably adapted on the basis of the determined at least one characteristic. In a third step 103, the distributed system 1 is provided on the basis of the adapted control function and/or the adapted communication parameter.

FIGS. 3a to 3c each show different possibilities for a deployed distributed system 1. According to FIG. 3a, the at least two components 2 or 2,3 are each designed as a vehicle. According to FIG. 3b, one of the at least two components 2 is designed as a vehicle and the other component 2,3 as an infrastructure system. According to FIG. 3c, one of the at least two components 2 is designed as a vehicle and the other component 2,3 as an external data processing system, in this case as a cloud server.

Control functions in general and in a distributed system 1 can behave differently due to different implementation situations or different planned behavior (more aggressive, shorter cycle time, etc.). The prioritization of communication channels in a distributed system can be linked to the behavior of the control function, e.g. with control gain or similar, in order to achieve the best communication results with the lowest overhead. Control parameters (e.g. aggressiveness, periodicity, etc.), i.e. parameters of a control function should preferably not be fixed, but vary depending on the communication channel. This channel estimation can be based on past or future events and use, for example, machine learning methods to generate a good abstraction for the controller or control function. The control function can further be evaluated in terms of a time criticality, e.g. the allowable latency or time horizon, and this can be used for the information about the communication channel.

Complex functions in particular require a closed control loop in order to react to and control various actuator or sensor data. If the control function is not used on a fixed target, but in a distributed system 1, e.g. Cloud/Edge, the resources for the control function may change.

With reference to FIG. 2, a method according to an exemplary embodiments is described below. According to a first step 201, measurement data is optionally requested from another vehicle 3 or another infrastructure 3. In particular, this is only necessary if the data already transmitted via the wireless communication 4 is not suitable for the measurements, i.e. determining the at least one characteristic of the wireless communication 4. The next step 202 is to measure the communication link. Thereafter, or in the context thereof, the at least one characteristic of the wireless communication 4 can be determined. This can be of the following type, for example:
A latency in the transmission of data,
A data transmission rate of wireless communication 4,
A periodicity in a transmission of data,
Availability of a wireless communication data connection 4,
A data integrity of wireless communication data 4.
   The control function is preferably not designed for a fixed communication, but can react (or be parameterized) according to step 204 to the above-mentioned different communication qualities, i.e. the different characteristics of the wireless communication 4. In particular, the change in the control function depends on at least one or all of these and leads to an optimization problem for which various possible solutions are suitable. A machine learning model can be used that can learn for which properties which parameters of the control function are best to be changed. Furthermore, methods from uncertainty quantification can be used to characterize the behavior of the distributed system 1 in addition to the nominal parameters (periodicity, latency, etc.). An optimal reparameterization of the control gain for the new conditions can be calculated e.g. by stochastic linear-quadratic optimal control design. In addition, classical functions or methods can also be used that change one or more parameters of the control function depending on one or more characteristics of the wireless communication 4. For example, a deterioration in the availability of the communication link could lead to a shift to a lower frequency in the calculation of the control function and/or with a lower estimation horizon or lower accuracy.

In addition, the execution of the adaptation or adjustment of the control function can take into account the current state of the implementation (critical/non-critical) based on a history (e.g. stable mode at target value or transient situation). This means that an adaptation can be blocked in an inappropriate situation. In addition, a transient, or change to a safe mode, can be triggered if no valid solution can be found.

Furthermore, the control function according to step 205 may provide a feedback and/or request a change of the wireless communication qualities, i.e. an adjustment of at least one communication parameter of the wireless communication 4. These communication parameters can be adjusted as follows:
Prioritizing communication channels of wireless communication 4,
Changing a communication channel used for wireless communication 4,
Changing a periodicity in the transmission of data,
Changing a modulated coding scheme when transmitting data.

The following parameters can be adjusted for the control function:
Configuring a control gain of the control function,
Adjusting at least one target value and/or reference value of the control function,
Adjusting a resource demand of the control function,
Adjusting a periodicity of an activation of the control function,
Adjusting a communication behavior of the control function.

Based on the above explanations, three degrees of freedom are possible in particular with regard to the control function and wireless communication 4:
Adjusting only the control function,
Adjusting only the wireless communication 4,
Joint adjusting control function and wireless communication 4.

An example of a method according to embodiments is shown below. Consider a closed system that is subject to communication delays between the sensor and the controller τₛ(p_{com}). The mechanisms that lead to such effects are outlined below. The system P is driven by sampled feedback and is given, for example, by

$$y ( t ) = P ( u ( t ) ) , \\ u ( t ) = uk für t ∈ [ {t}_{k} , {t}_{k} + h ( {p}_{ctrl} ) ) , {t}_{k} = kh ( {p}_{ctrl} ) , k = 0 , 1 , 2 , … \qquad ( 1 )$$

Above, the control sampling time h∈p_{ctrl} is an example control parameter or parameter of the control function. In the following examples, the system P describes in particular an actual movement of a real vehicle that interacts with the controller, i.e. in which the control function is implemented. In the case of an autonomous driving scenario, the output y is in particular a current position of the vehicle to be controlled or a distance to another unit, e.g. another vehicle, a pedestrian or a cyclist. The control signal uₖ is determined by a controller C that can rely on delayed output signals τ_{s/c}(p_{com}) which determine the sampling time H(p_{com}) and a desired output y_{d}(p_{ctl}).

$${u}_{k} = C ( y ( t - {τ}_{s / c} ( {p}_{com} ) , ) , {y}_{d} ( {p}_{ctrl} ) , {p}_{ctrl} ) \\ y ( t ) = {y}_{n} für t ∈ [ {t}_{n} , {t}_{n} + H ( {p}_{com} ) ) , {t}_{n} = nH ( {p}_{com} ) , n = 0 , 1 , 2 , … \qquad ( 2 )$$

Depending on the actual selection of the control parameters p_{ctrl} the controller or the control function can have different operating modes and different resource requirements, as outlined above. A simple example would be a PID controller with the control gain {C_{P}, C_{I}, C_{D}}∈p_{ctrl}. In addition, the desired output y_{d} to be tracked can also be one of the controller's degrees of freedom. If the output y is a distance between vehicles, the desired distance is, for example, a speed-dependent function such as y_{d}(v, p_{ctrl})=a+b v. The example parameters {a, b}∈p_{ctrl} can determine how close the distance should be.

For the controlled system (1)-(2), there is in particular a performance index that can depend on the desired and actual performance J(y, y_{d}). The control deviation e(t)=y_{d}(t)−y(t) is preferably a choice that is typically included in the performance index. Since both are time signals, Jₙ=J(tₙ) in particular is also a time signal that can be tracked during runtime. A typical choice can be the average of the last N-values

$${J}_{n} = \frac{1}{\frac{1}{N} {\sum }_{i = n - N}^{n} \vert {y}_{d , i} - {y}_{i} \vert} \qquad ( 3 )$$

Alternatively, other distance metrics such as the maximum error in a certain time frame can also be used.

Due to the dynamics (1)-(2) of the closed control loop, the performance index J depends in particular implicitly on the control and communication parameters p_{ctrl}, p_{com} since a different choice leads to a different behavior of the real system. However, this function

$$J ( y , {y}_{d} ) = f ( {p}_{ctrl} , {p}_{com} ) \qquad ( 4 )$$

cannot usually be derived in closed form. Nevertheless, optimization can be carried out at runtime, as an update of p_{ctrl}, p_{com} can lead to a reaction of the system and changes to the performance index.

Based on optimization methods (e.g. gradient-based solvers or global optimizations), an optimal choice x * for the degrees of freedom x⊆(p_{ctrl}∪p_{com}) can be found as a solution to the optimization problem, depending on whether communication and/or control parameters are to be optimized.

$$x *= arg max \times J s . t . {c}_{ineq} ( x ) \leq 0 , {c}_{eq} ( x ) = 0 \qquad ( 5 )$$

In addition, inequality and equality conditions for the degrees of freedom can also be taken into account, such as a lower power limit that must not be violated or minimum/maximum communication frequencies that must be adhered to. As outlined above, the objective function (4) or the optimal solution (5) can be learned or modeled using machine learning techniques and combined with the above methods to quantify uncertainty.

The following use cases according to FIGS. 3a to 3c are possible, with direct communication technologies between vehicle 2 and vehicle 2,3 (FIG. 3a) or vehicle 2 and infrastructure 2,3 (FIG. 3b) or vehicle 2 to network 2,3 (FIG. 3c). The first two use cases preferably use direct communication technologies such as ITS-G5 (802.11p) or PC5 (LTE-V2X/C-V2X/5G-V2X) and the third use case preferably uses mobile communication technologies such as 4G, 5G or 6G. In all variants, data is preferably transmitted to the left-hand vehicle 2 and received by a CCU, and the evaluated communication qualities are transmitted to the Automated Driving Controller (ADC), where the controller with the control function could be located. If the transmitted data is not suitable for the measurements, the left-hand vehicle can optionally request additional or selected measurement data, which is transmitted from the right-hand communication device 2,3 to the left-hand vehicle.

A detailed example of an application scenario for a distributed system 1 is described in FIG. 4. The use case relates to infrastructure-assisted automated driving (IAD), in which an infrastructure system 2,3 can control or support a connected vehicle 2. In this case, the infrastructure system 2,3 comprises a camera as an environmental sensor and a local infrastructure with direct communication options such as ITS-G5 and/or C-V2X. The infrastructure system 2,3 recognizes objects in the region of interest, in this case the red vehicle 6, the vehicle car 2 and the bicycle 5. The red vehicle 6 and the cyclist 5 are not connected, while the white vehicle 2 is a connected vehicle that has registered with the IAD service or has previously informed the infrastructure system 2,3 that it wants assistance and is signaling where it wants to go. The infrastructure system 2.3 then continuously monitors the situation and plans an efficient and safe driving proposal. The driving suggestion for the white vehicle 2 is sent via wireless data packets and includes user data with a time stamp and a trajectory with speed recommendations for several sections of the trajectory. Alternatively, direct commands for steering and acceleration can also be sent. This information is then used in the white vehicle 2 to control the lateral and longitudinal movement. For example, if the communication delay between the infrastructure system 2,3 and the white vehicle 2 increases during the maneuver, the white vehicle 2 can use this information to detect this in real time and, for example, execute a control gain less aggressively so that the white vehicle 2 can still drive smoothly and comfortably via the wireless communication 4. If the user data is not suitable to measure the communication channel, additional measurement data can be requested and transmitted by the infrastructure system 2,3 to support the detection of the communication quality, i.e. the at least one characteristic of the wireless communication 4.

The above explanation of the embodiments describes the present invention solely within the scope of examples. Of course, individual features of the embodiments may be freely combined with one another, if technically feasible, without leaving the scope of the present invention.

1. A method for providing an adjustable distributed system, comprising:
determining at least one characteristic of a wireless communication (4) between at least two components of the distributed system;
adjusting at least one parameter of a control function of one of the at least two components and/or at least one communication parameter of the wireless communication based on the determined at least one characteristic; and
providing the distributed system based on the adjusted at least one parameter of the control function and/or the adjusted communication parameter.

2. The method according to claim 1, wherein the adjusting of the at least one communication parameter is carried out only after the adjusting of the at least one parameter of the control function has been carried out or when the adjusting of the at least one parameter of the control function is disabled.

3. The method according to claim 1, further comprising:
initiating a request to determine the at least one characteristic of the wireless communication by another component of the distributed system.

4. The method according to claim 1, wherein the at least one characteristic of the wireless communication includes at least one of:
a latency in a transmission of data,
a data transmission rate of the wireless communication,
a periodicity in the transmission of data,
an availability of a wireless communication data connection, and
a data integrity of wireless communication data.

5. The method according to claim 1, wherein:
the adjusting of the at least one parameter of the control function is carried out by a machine learning model, and
the machine learning model is based on a training in which the machine learning model carries out an optimization of the at least one parameter of the control function based on the at least one characteristic in order to fulfill at least one predetermined requirement on the control function according to the optimization.

6. The method according to claim 1, wherein adjusting of the at least one communication parameter comprises at least one of:
prioritizing communication channels of the wireless communication,
changing a communication channel used for the wireless communication,
changing a periodicity in a transmission of data, and
changing a modulated coding scheme when transmitting data.

7. The method according to claim 1, wherein adjusting of the at least one parameter of the control function comprises at least one of:
configuring a control gain of the control function,
adjusting at least one target value and/or reference value of the control function,
adjusting a resource demand of the control function,
adjusting a periodicity of an activation of the control function, and
adjusting a communication behavior of the control function.

8. The method according to claim 1, wherein one of the at least two components is a vehicle and the control function controls a vehicle function including a determination and/or provision of a driving trajectory for the vehicle.

9. The method according to claim 1, wherein a computer program comprises commands for causing a computer to carry out the method when the computer program is executed by the computer.

10. A device for data processing, configured to carry out the method according to claim 1.

11. A non-transitory computer-readable storage medium, comprising commands which, when executed by a computer, cause the computer to carry out the method according to claim 1.
